(19) United States
(12) Patent Application Publication
(10) Pub. No.: US 2010/0198661 A1
(43) Pub. Date: Aug. 5, 2010

(54) SUPPLIER PORTFOLIO INDEXING

(75) Inventors: Paul Mitchell McMurray, Charlotte, NC (US); Mary Frances Edwards, Charlotte, NC (US); Margaret Susan Lipps, Charlotte, NC (US); Kevin Michael Woerner, Charlotte, NC (US); Gary Francis Page, Concord, NC (US); Caroline Kaminer Dellinger, Charlotte, NC (US); Gregg Sloan, Upatoi, GA (US); Karen Webb Bailey, Concord, NC (US); Laurie Venzon, Davidson, NC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, CHARLOTTE, NC (US)

(21) Appl. No.: 12/362,652

(22) Filed: Jan. 30, 2009

(51) Int. Cl. G06Q 10/00; G06N 5/02; G06Q 50/00

(52) U.S. Cl. 705/11; 705/7; 706/46

(57) ABSTRACT

Supply chain management using a supplier portfolio index (SPI) is disclosed. A single risk and performance metric for a supplier can be used across portfolios at both the business unit and enterprise level. The SPI can be produced by stratifying suppliers to obtain a plurality of risk element scores, which in turn are used to obtain a composite supplier risk index. A supplier performance scorecard metric can also be determined by combining a plurality of individual performance metrics. The composite supplier risk index, the supplier performance scorecard metric, and an indication of supplier manager certification can be aggregated to produce SPI. Percentage weights can be applied to the composite supplier risk index, the supplier performance scorecard metric, and the indication of supplier manager certification status so that the SPI is indicated on a 100-point scale.

### CROSS-REFERENCE TO RELATED APPLICATIONS

At least some of what is disclosed in this application is also disclosed in U.S. patent application Ser. No. ______, entitled, “Supplier Risk Evaluation,” and U.S. patent application Ser. No. ______, entitled, “Supplier Stratification,” both of which were filed in even date herewith, are commonly assigned, and are incorporated herein by reference.

### BACKGROUND

Operation of a successful business today requires the ability to collaborate with companies throughout the world. Further, oftentimes today's businesses are of such a complex nature that numerous suppliers of goods and services are utilized by a single business. Risk is an important factor to be considered whenever any kind of interaction is implemented between a contracting business and a supplier. Risk factors that are of particular concern when contracting with suppliers of goods and services include any factors that could expose a business to loss or theft, as suppliers often have direct access to proprietary business systems and information. However, supplier performance must also be monitored, to ensure that a business's use of a given supplier is cost-effective. Businesses therefore tend to expend valuable resources managing and mitigating risk factors inherent to supplier relationships, as well as monitoring the performance of each supplier. Such resources tend to be allocated subjectively and don't tend to take into account all of the factors that may play into a multi-faceted contractor-supplier relationship.

Suppliers may present risks to the business contracting with them in a number of different ways and performance factors that must be taken into account may vary from supplier to supplier. Thus, it is difficult to compare one supplier to another when many different variables must be taken into consideration. It can be challenging to know how to compare one supplier to another in terms of both risk and performance. It can also be a challenge to know how to weigh performance relative to risk.

### SUMMARY

Embodiments of the present invention provide a single risk and performance metric for a supplier that can be used across portfolios at both the business unit and enterprise level. This metric, referred to herein as a “supplier portfolio index” (SPI) is calculated by aggregating various component inputs, and can be disaggregated in order to understand the component inputs if additional information beyond the SPI itself is needed to manage a supplier or make decisions. The determination of an SPI for each supplier to facilitate comparisons between suppliers can be referred to as “supplier portfolio indexing.” A portfolio is a grouping of two or more suppliers by line of business, commodity, spend, or any of various other categorizations.

In at least some embodiments, the metric to indicate combined risk and performance for a supplier is produced by stratifying suppliers to obtain a plurality of risk element scores for the supplier, combining the risk element scores using relative weights to obtain a composite supplier risk index, determining a supplier performance scorecard metric by combining a plurality of individual performance metrics for the supplier, and combining the composite supplier risk index, the supplier performance scorecard metric, and an indication of supplier manager certification to produce the SPI. The SPI can be stored for use in reports or other process, displayed to a user, or both.

In some embodiments, the risk element scores from the supplier stratification can include an information security element score, a business continuity element score, a finance element score, an operational risk element score and a supply chain management element score. These scores can be equally weighted to obtain the composite supplier risk index. Alternatively these risk element scores can be weighted differently, for example to give the information security element score and the business continuity element score more relative weight than the other risk element scores.

In some embodiments, the composite supplier risk index, the supplier performance scorecard metric, and the indication of supplier manager certification status can be aggregated or combined by applying weights to each as a percentage to obtain a weighted composite supplier risk index, a weighted supplier performance scorecard metric, and a weighted indication of supplier manager certification status. Equal weights can optionally be used. These weighted values can then be added so that the SPI is indicated on a 100-point scale.

Embodiments of the invention are implemented via either a stand-alone instruction execution platform or such a platform interconnected with other platforms or data stores by a network, such as a corporate intranet, a local area network, or the Internet. A computer program product or computer program products contain computer programs with various instructions to cause the hardware to carry out, at least in part, the methods and processes of the invention. Data sets may include risk element scores obtained from stratifying suppliers and the individual performance metrics. These data sets may be stored locally or accessed over the network. Dedicated software can be provided to implement an embodiment of the invention, or alternatively, a spreadsheet program can be used to implement embodiments of the invention. In either case a user screen is operable to receive appropriate input and to provide output.

### BRIEF DESCRIPTION OF THE DRAWINGS

FIG. 1 is a schematic illustration of how various scores and metrics are combined to calculate the supplier portfolio index according to example embodiments of the present invention.

FIG. 2 is a flowchart illustrating a process of an example embodiment of the invention.

FIG. 3 is another flowchart illustrating further detail of the example process illustrated by the flowchart of FIG. 2.

FIG. 4 is a system block diagram illustrating apparatus and an operating environment for carrying out at least some embodiments of the present invention.

### DETAILED DESCRIPTION OF THE INVENTION

The following detailed description of embodiments refers to the accompanying drawings, which illustrate specific embodiments of the invention. Other embodiments having different structures and operation do not depart from the scope of the present invention.

The present invention can be embodied in computer software or a computer program product. An embodiment may include a spreadsheet program and may also include appropriate macro programs, algorithms, or plug-ins. An embodiment may also consist of a custom-authored software application for any of various computing platforms. One specific example discussed herein involves the use of a Windows™ personal computing platform running Microsoft Excel™ spreadsheet software. It cannot be overemphasized that this embodiment is an example only. It will also be readily understood that the inventive concepts described herein can be adapted to any type of hardware and software platform using any operating system including those based on Unix™ and Linux. In any such embodiments, the instruction execution or computing platform in combination with computer program code instructions form the means to carry out the processes of the invention.

The following description is based on an exemplary implementation of an embodiment of the invention in a financial institution, but it is understood that the present invention could be useful in many different types of businesses and the example herein is not intended to limit the use of the invention to any particular industry. The term “financial institution” refers to an institution that acts as an agent to provide financial services for its clients or members. Financial institutions generally, but not always, fall under financial regulation from a government authority. Financial institutions include, but are not limited to, banks, building societies, credit unions, stock brokerages, asset management firms, savings and loans, money lending companies, insurance brokerages, insurance underwriters, dealers in securities, and similar businesses.

Embodiments of the present invention can find use in a global supply chain management program for an enterprise such as a bank, manufacturing company, insurance company, or any other business. Such a management program can constitute a framework of governance, processes and tools to manage enterprise supplier risk and performance annually, or at any other frequency desired. As part of such a framework, supplier managers and suppliers can submit program deliverables which enable the enterprise to assess, manage, and mitigate supplier performance and risk issues in a timely manner.

Risk may need to be managed to internal standards developed by the enterprise. Additionally, risk may need to be managed due to external regulations and standards. For example, a financial institution such as a bank in the United States may need to manage risk to meet requirement imposed by the government, such as those specified in statutes such as the USA Patriot Act, the Gramm-Leach-Bliley Act, and the Sarbanes-Oxley Act.

Banks in the United States are also regulated by the Office of the Comptroller of the Currency (OCC) and need to mitigate risks imposed by having to comply with OCC regulations. The focus of the OCC regulations is on safety and soundness. For a financial enterprise, operational risk is a critical concern. Operational risk is the risk of direct and indirect loss due to people, processes, technology, regulation, external events, execution, or reputation.

Supplier management is concerned with one form of external events risk. External events risk is the risk from outside the businesses' normal span of control. Events risk may include risks posed by vendors, alliances, and service providers. Third-party supplier services can be considered an extension of an enterprise's internal operations. It is the enterprise's responsibility to ensure the quality of operations and controls provided by a supplier.

As used here, either the term “contractor” or the term “enterprise” can used to refer to the primary business that has entered into a contractual agreement with a “supplier” for goods or services. A “supplier” is a business that provides goods or services. A “subcontractor” is an entity hired by a supplier. A subcontractor does not have a direct contractual agreement with the contractor. “Offshore” work refers to work that is located in a country other than that in which the contract between the contractor and the supplier was executed, and doing such work may be referred to herein as “offshoring.”

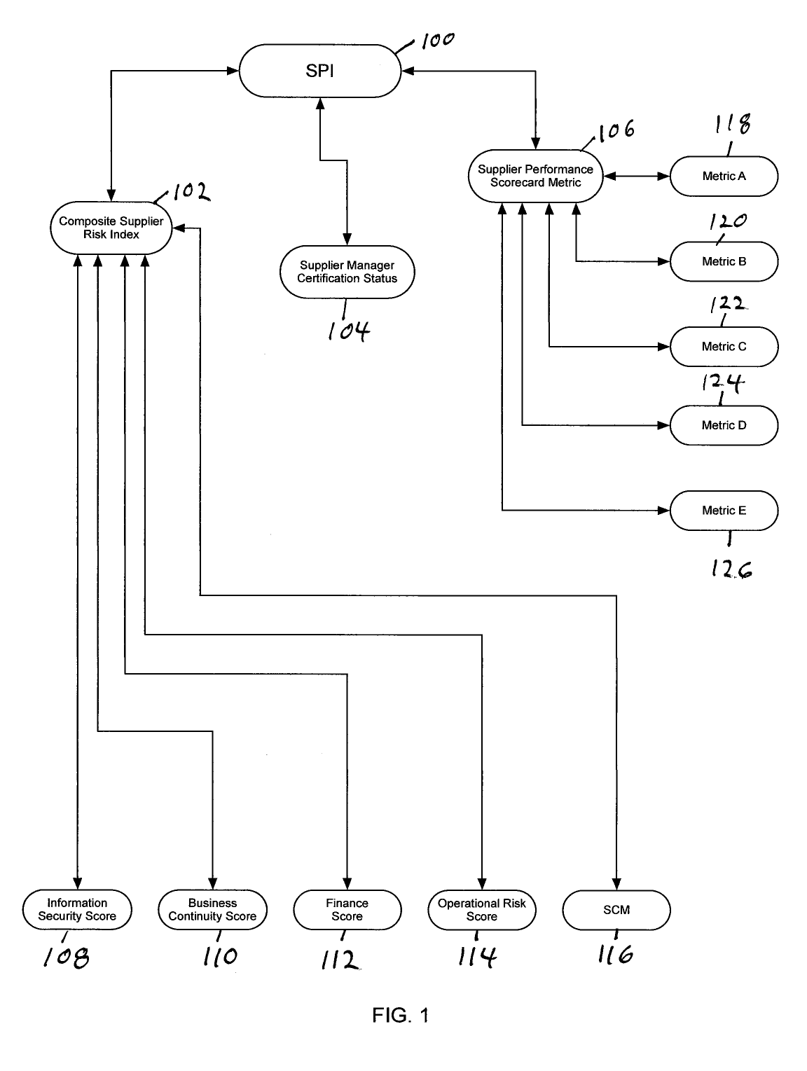

According to example embodiments of the present invention, suppliers can be indexed using a supplier portfolio index (SPI). FIG. 1 diagrammatically illustrates the components of SPI 100. In example embodiments, the SPI consists of three equally-weighted metrics. One metric is referred to herein is the composite supplier risk index (CSRI), 102 of FIG. 1. A second metric is the supplier manager certification status, 104 of FIG. 1. The third metric is the supplier performance scorecard metric, 106 of FIG. 1.

The CSRI in the example embodiments, 102 of FIG. 1, is determined by five categories of risk, each defined by a risk element score. The five risk element scores used to calculate the CSRI in this example are information security score 108, business continuity score 110, finance score 112, operational risk score 114 and supply chain management (SCM) score 116. The SCM score defines contract related risk and is determined from survey questions posed to the supplier. In some embodiments, each of these element scores can be weighted equally. However, it may be advantageous to weight them differently. Weighting can be developed for a specific enterprise as needed. For a large financial institution, a weighting 30% for the information security and business continuity element scores, 16% for the operational risk elements score, and 12% for each of the SCM element score and the finance element score has been found to be effective. The weighted risk element scores are added together to produce CSRI 102 on a 100-point scale.

The risk element scores and the CSRI in some embodiments can be obtained through supplier stratification. A software tool for supplier stratification can be implemented to provide a method and system of stratifying/ranking a supplier of goods or services. A tier level is calculated for the supplier based on answers provided to a series of multiple-choice questions. The multiple-choice questions are used to identify and measure risk elements associated with the supplier. It will be understood by one of skill in the art that the tier level may be aligned to any risk element(s) seen to be potentially harmful to the business. To provide input to the calculation of the SPI, the tier level includes a measure of the five risk elements used in the CSRI. However, the stratification tool can also measure additional risk elements. In at least some embodiments, the assigned tier level includes a measure of risk across many defined risk elements, measured by the multiple-choice questions. In stratification, the term “risk” refers to the probability that there will be a loss to the business. The loss may be a direct financial loss. The loss may also be nonfinancial on its face, such as damage to the business's reputation amongst customers.

Multiple choice and/or yes/no questions can be used not only in the stratification portion of obtaining an SPI according to example embodiments of the invention, but also to gather input for the other metrics that make up the SPI. Such multiple-choice questions provide an interface between the user and the sophisticated risk analysis underlying the multiple-choice questions. Each question has multiple answer options that are each assigned a question value, wherein the question values fall within a predetermined value range, for example within a range of 1-5.

Throughout this discussion, it should be noted that in the example provided, an inverted scoring logic is implemented with respect to risk, so that larger scores correlate with lower risk. It should be noted however that since the SPI also takes performance into account, as will be detailed below; the SPI is not inverted with respect to performance because a higher number correlates to better performance.

In some embodiments, stratification can produce two risk measurements, an initial measurement of “inherent” risk, which can be reflected in an inherent risk index (IRI) and a measurement of remediated risk, which can be reflected in a remediated risk index (RRI). Remediation is the process of the supplier putting processes and/or safeguards in place to reduce the risk uncovered initially when the IRI was determined. If no remediation is undertaken, either because none is needed, or for any other reason, the RRI will be the same as the IRI. In either case, it would normally be the risk element scores determined when the RRI is calculated that would be used to determine the CSRI and in turn to determine the SPI. An example stratification tool that can be used with example embodiments of the present invention is described in U.S. patent application Ser. No. ______, entitled, “Supplier Stratification,” filed on even date herewith, the entire disclosure of which is incorporated herein by reference.

Referring again to FIG. 1, it should also be noted that in some enterprises, a threshold may be set below which information security element score 108 obtained from survey questions posed by the stratification tool would not be initially acceptable, with the result being that an information security assessment of the supplier would be undertaken by the enterprise. Likewise, a threshold may be set below which business continuity element score 110 obtained from survey questions posed by the stratification tool would not be initially acceptable, with the result being that a business continuity assessment would be undertaken by the enterprise. In either situation, or if both situations apply as the case may be, the score from the assessment conducted by the enterprise would normally become the element score used to determine the CSRI.

For completeness it should be noted that as part of supplier stratification, risks posed to a business by a supplier of goods or services, wherein the supplier subcontracts the production of the goods or services to a third entity, offshores the production of the goods or services, or uses an offshore subcontractor to provide the goods or services can also be determined. A risk score is calculated and is used to drive risk mitigation and management of the supplier. This risk score is again calculated from answers to a series of multiple choice questions, wherein the multiple choice questions are used to establish risk factors associated with such a supplier's situation. An example of risk evaluation with respect to offshoring is described in U.S. patent application Ser. No. ______, entitled, “Supplier Risk Evaluation,” filed on even date herewith, the entire disclosure of which is incorporated herein by reference.

Referring again to FIG. 1, supplier manager certification status 104 is another metric that is used to calculate the SPI. In example embodiments, a supplier manager within the enterprise can be trained, pass a test, and become “certified” to manage a supplier in the global supply chain management program with which an embodiment of the present invention is being used. In this example embodiment, the supplier manager certification status metric takes on a value of zero if the manager for the particular supplier is not certified and 100 if the manager for the particular supplier is certified.

In a typical enterprise, a supplier manager would be assigned by a business unit, or so-called “line of business” (LOB). In one specific example, for a supplier manager to be certified, the manager must complete a 2-3 day training program, pass the certification test within 60 days of completing the program, and be recertified annually. A supplier manager can serve as a liaison between the supplier and the contracting enterprise. The supplier manager can define supplier service level agreements and corresponding performance metrics (discussed in further detail below with respect to the supplier performance scorecard metric). The supplier manager may maintain an understanding of the terms and conditions of the contract between enterprise and the supplier and manage the supplier to all terms and conditions of the contract. The supplier manager also often drives mitigation actions, resolves and/or escalates issues and monitors the quality and timeliness of deliverables. The term, “supplier manager” is not meant to be limiting. Any person associated with the enterprise who performs these or similar functions can be considered a “supplier manager” for purposes of implementing an embodiment of the invention, irrespective of the person's actual title as an associate of the enterprise.

Continuing with FIG. 1, the third metric that is used to calculate the SPI according to these example embodiments is supplier performance scorecard metric 106. The supplier performance scorecard metric adds a performance component to the SPI. Any number of performance metrics for a given supplier can be taken into account. Performance metrics are typically goals that must be met according to service level agreements with the supplier. For example, there may be a metric that a certain deliverable must be on time 98% of the time. In the case of a financial institution, there may be metrics related to check sorting accuracy, statement printing errors, and the like. For purposes of this example, the metrics used for the SPI will be referred to as metric A 118, metric B 120, metric C 122, metric D 124, and metric E 126.

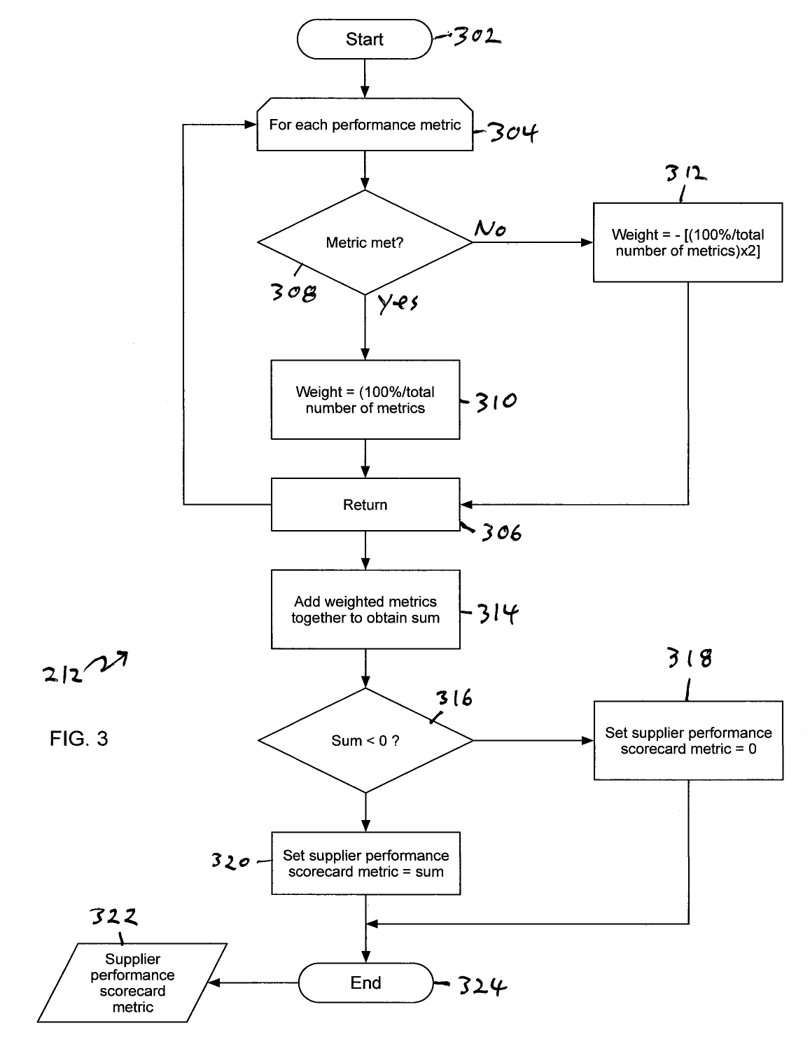

In one example embodiment, the supplier performance scorecard metric is calculated by receiving an indication of which metrics are met and which metrics are not. The percentage each met metric counts towards the overall score is determined by dividing the number of metrics into 100. For instance, in the case of FIG. 1, since there are five metrics, each one that is met counts for 20%. However, in this embodiment, a metric that is not met is double counted. So for example, if four metrics are met out of five, the supplier performance scorecard metric is 80 for those four metrics. Since one metric is not met, however, that one is double counted, and subtracted twice from a possible total of 100, leaving an overall supplier performance scorecard metric of 60. An example of this type of calculation for the supplier performance scorecard metric is discussed with respect to FIG. 3 later.

In another embodiment, the supplier performance scorecard metric is calculated by evaluating each individual performance metric on a scale, and weighting each individual performance metric to determine its contribution to the overall supplier performance scorecard metric. This method of calculating the supplier performance scorecard metric can make use of answers provided to a series of multiple-choice questions about performance criteria. Such entries into a software tool rate performance on numerical scale, for example, 1-5, and thus measure performance elements associated with the supplier.

To calculate the SPI, once the three input metrics are determined, each is multiplied by a percentage weight. Each individual input metric for the SPI will be expressed on a 100-point scale, essentially as a percentage. For example, staying with FIG. 1, CSRI 102, supplier manager certification status 104, and supplier performance scorecard metric 106 can all be weighted equally, in which case each is multiplied by 33.33%, and the resulting weighted metrics, each expressed as a percentage, are added together to obtain the SPI expressed on a 100-point or percentage scale.

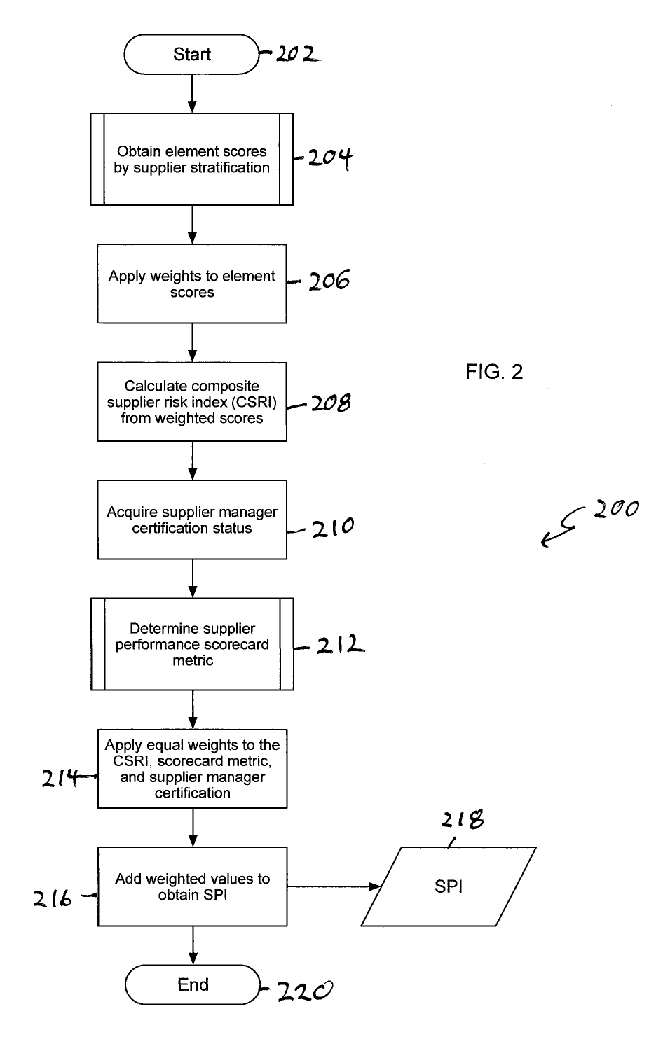

FIG. 2 illustrates, in flowchart form, the process of obtaining the SPI according to example embodiments of the invention. Like most flowchart illustrations, FIG. 2 illustrates the process of obtaining the SPI as a series of process or sub-process blocks. Process 200 of FIG. 2 begins at block 202. At block 204, risk element scores are obtained, for example, using the aforementioned supplier stratification tool. Weights are then applied to the element scores at block 206. For example, each element score can be weighted equally. However, weighting can be developed for a specific enterprise as needed. For example, a weighting 30% for the information security and business continuity element scores, 16% for the operational risk elements score, and 12% for each of the SCM element score and the finance element score can be used.

Still referring to FIG. 2, the composite supplier risk index (CSRI) is calculated at block 208 from the weighted risk elements scores. At block 210, the supplier manager certification status is determined. The status may be acquired through user input, or possibly acquired from a database. A record might be made in a database, for example, showing that a supplier manager has completed a training program and passed a certification test. At block 212, the supplier performance scorecard metric is determined. A detailed flowchart of this sub-process is presented in FIG. 3 and further discussed below.

Continuing with FIG. 2, at block 214 equal weights are applied to the supplier performance scorecard metric, the supplier manager certification value, and the CSRI, and the weighted values are added together at block 216 to produce the SPI as illustrated schematically at 218. It should be noted that equal weights are used here as an example only. Different weighting could be used. Nonetheless, in this example, each individual input metric for the SPI will be expressed on a 100-point scale, and the resulting weighted metrics, each expressed as a percentage are added together to obtain the SPI expressed on a 100-point or percentage scale. Process 200 ends at block 220.

FIG. 3 illustrates one example process for determining the supplier performance scorecard metric. Process 212 of FIG. 3 is also shown as a sub-process of FIG. 2. Process 212 begins at block 302. In the initial part of process 212, the various supplier performance metrics are evaluated as indicated by loop limits 304 and 306. For each performance metric at block 304, input is received as to whether that metric has been met by the subcontractor at block 308. If the metric was met, a value is assigned to the metric at block 310. Specifically, the metric is assigned a value that makes it a percentage of the total scorecard metric by dividing 100 by the total number of metrics. Another way to conceptualize this value assignment is to think of the raw performance metric as being assigned a value of 1 for being met, and being equally weighted.

Still referring to FIG. 3, if the metric was not met at block 308, the metric is assigned a negative value at block 312 of twice the percentage it would be assigned by dividing 100 by the total number of metrics. Another way to conceptualize this value assignment is to think of the raw performance metric as being assigned a value of −2 for not being met, and being equally weighted. One could also express this value assignment as the raw performance metric being assigned a value of −1 and being doubly weighted when the metric is not met. In either case, once all metrics have been evaluated and weighted at block 306, the weighted values are added together at block 314.

Continuing with FIG. 3, a determination is made at block 316 as to whether the value for the sum obtained at block 314 is less than zero. To calculate the SPI, zero is the lowest value of any metric used. If the value of the sum is less than zero at block 316, the performance scorecard metric is set to zero at block 318. Otherwise, the performance scorecard metric is set at block 320 to the sum obtained at block 314. Supplier performance scorecard metric 322 is output from process 212 and process 212 ends at block 324.

It should be noted that the SPI can be calculated at whatever interval is needed for a given enterprise. All input metrics to the SPI can be updated at once, or only certain input metrics can be calculated at a preselected interval. It may be helpful for an enterprise, for example, to evaluate supplier performance scorecard metrics quarterly.

It should also be noted that a “met/not met” performance evaluation may be too punitive in some situations where a metric is only missed by a small amount. For example, if a supplier is required to print 98% of a certain bank account peripheral without errors, and the supplier, during a certain quarter, prints 97% without errors, there may be a need to have this “almost met” performance reflected in the suppler performance scorecard and ultimately in the SPI. In such a case, the supplier performance scorecard could be designed so that individual performance metrics used to determine the supplier performance scorecard metric can be given a range of values. The individual performance metrics also do not have to be weighted equally in the sense that each metric is given the same importance relative to the other metrics. Rather different weightings could be used if that is most appropriate for a given enterprise.

In either of the above two methodologies, the method of calculating the supplier performance scorecard metric can make use of answers provided to a series of questions about performance criteria. The answers can be input to a computer system by the supplier manager or another person in the enterprise. If a “met/not met” measuring philosophy is in place, these questions might simply be answered with check boxes or radio buttons. If each performance metric is to be assigned a range of values, multiple-choice questions can be used.

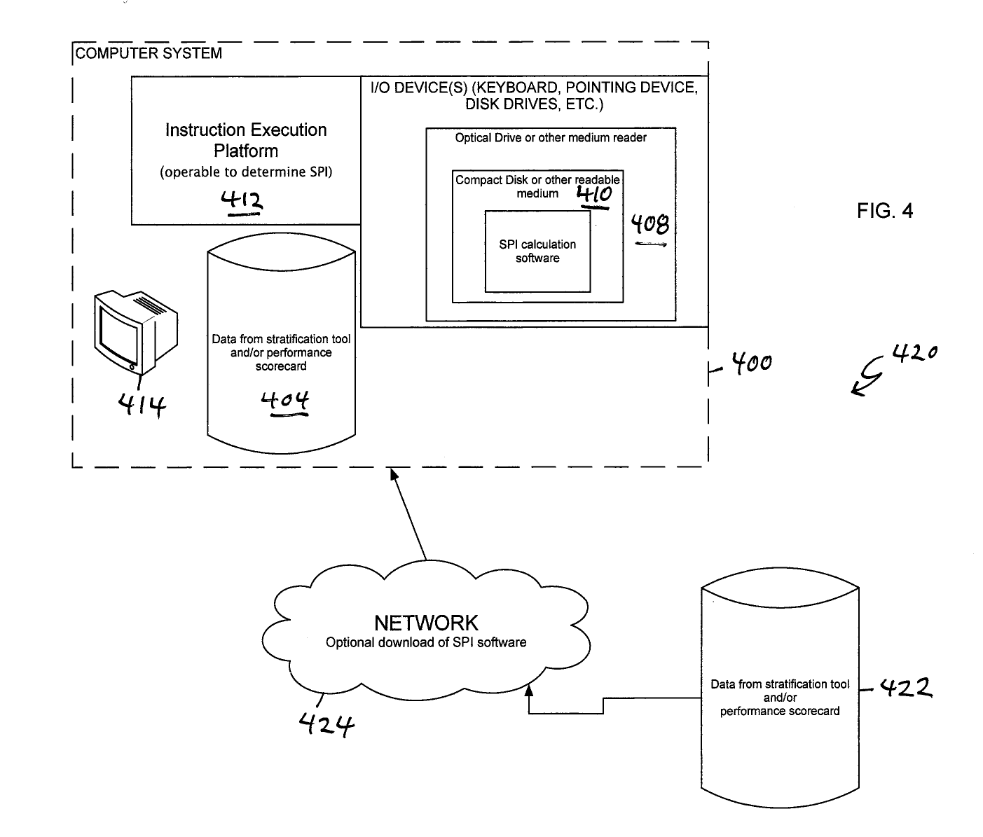

FIG. 4 is a system block diagram according to example embodiments of the invention. FIG. 4 actually illustrates two alternative embodiments of a system implementing the invention. System 400 can be a workstation or personal computer. System 400 can be operated in a “stand-alone” mode. The system includes a fixed storage medium, illustrated graphically at 404, for storing programs and/or macros which enable the use of an embodiment of the invention. In a stand-alone implementation of the invention, fixed storage 404 can also include the data sets, which are necessary to implement an embodiment of the invention. In this particular example, the input/output devices 406 include an optical drive 408 connected to the computing platform for loading the appropriate computer program product into system 400 from an optical disk 410. The computer program product includes a computer program or programs with instructions or code for carrying out the methods of embodiments of the invention. Instruction execution platform 412 of FIG. 4 includes a microprocessor and supporting circuitry and can execute the appropriate instructions and display appropriate screens on display device 414.

FIG. 4 also illustrates another embodiment of the invention in which case the system 420, which is implementing the invention, includes a connection to data stores 422, from which data from the stratification tool and supplier performance scorecard data can be obtained. The connection to the data stores or appropriate databases can be formed in part by network 424, which can be an intranet, virtual private network (VPN) connection, local area network (LAN) connection, or any other type of network resources, including the Internet. Data sets can be local, for example on fixed storage 204, or stored on the network, for example in data store 222. Software to implement an SPI tool can also optionally be downloaded via network 424.

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-readable storage medium having computer-usable program code embodied in the medium.

Any suitable computer usable or computer readable medium may be utilized to carry out the function of the computer readable media illustrated in FIG. 4. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the computer executable instructions stored in the computer readable memory produce an article of manufacture including instruction means which implement the function/act specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, action, or portion of code, which comprises one or more executable instructions or actions for implementing the specified logical function(s). It should also be noted that, in some alternative implementations, the functions noted described herein may occur out of the order presented, depending upon the functionality involved. It will also be noted that each block of the block diagrams and/or flowchart illustrations, and combinations of blocks in the block diagrams and/or flowchart illustrations, can be implemented by special purpose hardware-based systems or operators which perform the specified functions or acts.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, comparative, quantitative terms such as “above”, “below”, “less”, “greater”, are intended to encompass the concept of equality, thus, “less” can mean not only “less” in the strictest mathematical sense, but also, “less than or equal to.”

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A computerized method of producing a metric to indicate combined risk and performance for a supplier, the method comprising:
stratifying suppliers to obtain a plurality of risk element scores for the supplier;
combining the risk element scores using relative weights to obtain a composite supplier risk index for the supplier;
determining a supplier performance scorecard metric by combining a plurality of individual performance metrics for the supplier; and
combining the composite supplier risk index, the supplier performance scorecard metric, and an indication of supplier manager certification status to produce a supplier portfolio index.

2. The method of claim 1 wherein the risk element scores include an information security element score, a business continuity element score, a finance element score, an operational risk element score and supply chain management element score.

3. The method of claim 1 wherein the combining of the composite supplier risk index, the supplier performance scorecard metric, and the indication of supplier manager certification status further comprises:
applying weights to each of the composite supplier risk index, the supplier performance scorecard metric, and the indication of supplier manager certification status as a percentage to obtain a weighted composite supplier risk index, a weighted supplier performance scorecard metric, and a weighted indication of supplier manager certification status; and
adding the weighted composite supplier risk index, the weighted supplier performance scorecard metric, and the weighted indication of supplier manager certification status so that the supplier portfolio index is indicated on a 100-point scale.

4. The method of claim 2 wherein the relative weights cause the information security element score and business continuity element score to each be weighted more heavily than any of the finance element score, the operational risk element score and the supply chain management element score.

5. The method of claim 3 wherein the risk element scores include an information security element score, a business continuity element score, a finance element score, an operational risk element score and supply chain management element score.

6. The method of claim 5 wherein the relative weights cause the information security element score and business continuity element score to each be weighted more heavily than any of the finance element score, the operational risk element score and the supply chain management element score.

7. A computer program product comprising a computer-readable storage medium having computer-readable program code embodied therein, the computer-readable program code being executable to implement a method of producing a metric to indicate combined risk and performance for a supplier, the method comprising:
stratifying suppliers to obtain a plurality of risk element scores for the supplier;
combining the risk element scores using relative weights to obtain a composite supplier risk index for the supplier;
determining a supplier performance scorecard metric by combining a plurality of individual performance metrics for the supplier;
combining the composite supplier risk index, the supplier performance scorecard metric, and an indication of supplier manager certification status to determine a supplier portfolio index; and
at least one of displaying and storing the supplier portfolio index.

8. The computer program product of claim 7 wherein the risk element scores include an information security element score, a business continuity element score, a finance element score, an operational risk element score and supply chain management element score.

9. The computer program product of claim 7 wherein the combining of the composite supplier risk index, the supplier performance scorecard metric, and the indication of supplier manager certification status further comprises:
applying weights to each of the composite supplier risk index, the supplier performance scorecard metric, and the indication of supplier manager certification status as a percentage to obtain a weighted composite supplier risk index, a weighted supplier performance scorecard metric, and a weighted indication of supplier manager certification status; and
adding the weighted composite supplier risk index, the weighted supplier performance scorecard metric, and the weighted indication of supplier manager certification status so that the supplier portfolio index is indicated relative to a 100-point scale.

10. The computer program product of claim 8 wherein the relative weights cause the information security element score and business continuity element score to each be weighted more heavily than any of the finance element score, the operational risk element score and the supply chain management element score.

11. The computer program product of claim 9 wherein the risk element scores include an information security element score, a business continuity element score, a finance element score, an operational risk element score and supply chain management element score.

12. The computer program product of claim 11 wherein the relative weights cause the information security element score and business continuity element score to each be weighted more heavily than any of the finance element score, the operational risk element score and the supply chain management element score.

13. Apparatus for producing a metric to indicate combined risk and performance for a supplier, the apparatus comprising:
means for stratifying suppliers to obtain a plurality of risk element scores for the supplier;
means for combining the risk element scores using relative weights to obtain a composite supplier risk index for the supplier;
means for determining a supplier performance scorecard metric by combining a plurality of individual performance metrics for the supplier;
means for combining the composite supplier risk index, the supplier performance scorecard metric, and an indication of supplier manager certification status to determine a supplier portfolio index; and
means for storing the supplier portfolio index.

14. The apparatus of claim 13 further comprising:
means for applying weights to each of the composite supplier risk index, the supplier performance scorecard metric, and the indication of supplier manager certification status as a percentage to obtain a weighted composite supplier risk index, a weighted supplier performance scorecard metric, and a weighted indication of supplier manager certification status; and
means for adding the weighted composite supplier risk index, the weighted supplier performance scorecard metric, and the weighted indication of supplier manager certification status.

15. The apparatus of claim 14 further comprising means for displaying the supplier portfolio index relative to a 100-point scale.

16. A system for producing a metric to indicate combined risk and performance for a supplier, the system comprising:
an instruction execution platform operable to combine risk element scores to obtain a composite supplier risk index for the supplier, determine a supplier performance scorecard metric by combining a plurality of individual performance metrics for the supplier, and combine the composite supplier risk index, the supplier performance scorecard metric, and an indication of supplier manager certification status to produce a supplier portfolio index; and
a data set comprising the risk element scores obtained from stratifying suppliers and the plurality of individual performance metrics, the data set being disposed to be accessed by the instruction execution platform.

17. The system of claim 16 wherein the risk element scores include an information security element score, a business continuity element score, a finance element score, an operational risk element score and a supply chain management element score.

18. The system of claim 16 further comprising a display to display the supplier portfolio index.

19. The system of claim 16 further comprising a network interconnecting the instruction execution platform and the data set.

20. The system of claim 17 further comprising a display to display the supplier portfolio index.

21. The system of claim 17 further comprising a network interconnecting the instruction execution platform and the data set.

22. The system of claim 20 further comprising a network interconnecting the instruction execution platform and the data set.
